(19) United States
(12) Patent Application Publication
(10) Pub. No.: US 2010/0250219 A1
(43) Pub. Date: Sep. 30, 2010

(54) METHODS AND SYSTEMS FOR ACCURATE SIMULATION OF SURFACES AND INTERFACES OF FCC METALS

(75) Inventor: Hendrik Heinz, Uniontown, OH (US)

Correspondence Address: HAHN LOESER & PARKS, LLP, One GOJO Plaza, Suite 300, AKRON, OH, 44311-1076, US

(73) Assignee: THE UNIVERSITY OF AKRON, Akron, OH (US)

(21) Appl. No.: 12/677,686

(22) PCT Filed: Sep. 11, 2008
(86) PCT No.: PCT/US08/76031

§ 371 Date: Mar. 11, 2010

Related U.S. Application Data
(60) Provisional application No. 60/994,159, filed on Sep. 11, 2007.

(51) Int. Cl. G06G 7/58; C07B 61/00

(52) U.S. Cl. 703/12

(57) ABSTRACT

The Lennard-Jones parameters for metals, such as fcc metals, have been developed which are suitable for the simulation of the metals, alloys, and interfaces with water, organic, inorganic, and biological molecules. The models are compatible with common materials-oriented and biomolecular force fields, and can thus be integrated in commercial simulation packages to extend their applicability to any metal-related systems.

### CROSS-REFERENCE TO RELATED APPLICATION

This patent application is the national stage application of international application PCT/US08/76031, filed Sep. 11, 2008, which claims priority to and the benefit of U.S. Provisional Application Ser. No. 60/994,159 filed on Sep. 11, 2007, the entire disclosure of which is hereby incorporated by reference.

### FIELD OF THE INVENTION

The present invention relates to systems and methods for simulation of the interaction of fcc metals. More particularly, the invention relates to simulations for determination of the interaction of fcc metals with other materials using Lennard-Jones potentials, and the determination of properties such as densities and surface tensions under standard conditions, which also leads to significantly improved results for determination of surface energy anisotropies, interface tensions, and mechanical properties. The invention may be used to simulate interaction with a variety of interfaces with biopolymers, surfactants, and other nanostructured materials through compatibility with widely used force fields for example.

### DESCRIPTION OF RELATED ART

Metals and alloys serve traditionally as load bearing structures, conductors, and materials for accessories. Recently, metallic nanostructures and their interfaces with biological molecules, surfactants, solvents, and organic matter have shown promise for application in sensors, optical applications, electronic applications, and biomedical devices. Examples include the surfactant-directed growth of metal nanostructures as well as the selective binding of peptides and specifically designed cell surfaces to metal nanoparticles. The understanding of such nanometer-scale processes, the interpretation of experimental data, and the choice of suitable surface-surfactant combinations, alloys, and morphological features is often difficult and can be advanced through simulation. Examples include the explanation of X-Ray diffraction, dielectric, IR, SFG, UV, NMR, DSC, AFM, and TEM data on the basis of simulation for some inorganic-organic hybrid materials such as organically modified layered silicates, although rarely yet for metal-related interfaces. Therefore, there is a need to increase the value of and accuracy of simulations of the interactions with metals. Previously, simulations have been attempted using Lennard-Jones parameters for the simulation of face centered cubic (fcc) elemental metals and their nanometer-scale interfaces, but such simulations have not been accurate thereby decreasing their value. With other metals or biominerals, simulations have generally not been possible.

For the successful combination of experiment and simulation, the reliability of computational models and their compatibility with existing simulation tools are important. For systems containing elemental metals, models can be distinguished in three broad categories. (1) At the electronic structure level, tight-binding, density functional, or other quantum-mechanical methods can be employed for small clusters of metals and interfaces (˜10³ atoms) to simulate dynamical processes on the order of ps. Average deviations in densities, surface, and mechanical properties range from 2% to 20% relative to experiment and are associated with uncertainty about the exact exchange-correlation functional as well as the treatment of relativistic effects in the presence of d and f electrons. (2) At a semi-empirical level, embedded atom models (EAM) are available for larger assemblies (˜10⁴ atoms) and longer simulation times. Although the computational cost of this approach is lower, agreement with experiment is less satisfactory compared to the tight-binding approach. Particularly, surface energies are underestimated up to 50%, and compatibility with existing semi-empirical parameter sets (force fields) for organic molecules, polymers, and biomacromolecules is difficult to achieve. (3) At the classical mechanical level, Lennard-Jones (LJ) potentials can be employed for substantially larger systems (˜10⁶ atoms), and dynamical processes on a time scale up to 1 μs are accessible. This is more than a million times faster than quantum-mechanical methods, and a variety of force fields for biological and organic molecules are available which include LJ parameters. However, existing LJ potentials for metals have been poor approximations with deviations in surface and mechanical properties on the order of 100% relative to experiment under ambient conditions, and are thus often omitted in major force fields.

It is believed the discrepancies between model and experiment are related to physical misunderstanding of the LJ parameters for fcc metals, and there is therefore a need for more accurate LJ parameters under ambient conditions which can be used with existing force fields for the simulation of metals and hybrid interfaces using molecular dynamics and Monte Carlo methods.

### SUMMARY OF THE INVENTION

The invention in one aspect is directed to a method for developing molecular mechanics force field parameters for computer simulations of molecular systems including at least one metal. The method comprising creating or importing molecular models to a processor of a computer system, the molecular models representing said molecular systems having at least one metal to be parameterized. Retrieving stored Lennard-Jones parameters relating to at least one metal, wherein said Lennard-Jones parameters relate to surface and interface properties, and wherein the Lennard-Jones parameters deviate less than between 1% and 20%. Preparing input data for the molecular models, selecting force field type and functional forms, and assigning atom types to the molecular models, and providing force field parameters for the molecular models based on the molecular models. The force field parameters can be exported in predetermined formats to at least one external molecular mechanics simulation package, and saving of the molecular models, input data and force field parameters to a database may be performed.

The invention also relates to a method to parameterize models that are compatible with materials-oriented and biomolecular force fields for use in an external molecular mechanics simulation package. The method comprising providing Lennard-Jones parameters relating to at least one fcc metal, said parameters relating to adjustment of two parameters r₀ and ∈₀ to densities and surface tensions of at least one metal at a given temperature and pressure. The Lennard-Jones parameters are imported to predetermined molecular models for performing simulations.

The invention further relates to a method of deriving Lennard-Jones potentials for metal materials. In this method, the steps of determining the values of at least density and surface tension at a predetermined temperature and pressure are provided for a predetermined metal. The values of at least density and surface tension are translated into first estimates of at least the two parameters r₀ and ∈₀ of a Lennard-Jones model. The density and surface tension are computed using the first estimates in a NPT and/or NVT molecular dynamics simulation. Using the computed density and surface tension, at least second estimates of the at least two parameters r₀ and ∈₀ are derived to adjust the values of said at least two parameters r₀ and ∈₀. Thereafter, the density and surface tension are computed using the second estimates in a NPT and/or NVT molecular dynamics simulation, and it is determined whether the second estimates provide predetermined results from the computation in the prior step. If the predetermined results are not provided, the steps of computing density and surface tension using the second estimates in a NPT and/or NVT molecular dynamics simulation, and using the computed density and surface tension to derive third or more estimates of the at least two parameters r₀ and ∈₀ are repeated until predetermined results from the computation in a NPT and/or NVT molecular dynamics simulation are provided to yield Lennard-Jones potentials for use in simulations in association with a predetermined metal.

Further, the invention is directed to a computer-implemented system for developing molecular mechanics force field parameters for computer simulations of molecular systems, comprising a means of creating or importing molecular models to a processor of a computer system, the molecular models representing said molecular systems having at least one metal to be parameterized. Further, means are provided for retrieving stored Lennard-Jones parameters relating to at least one metal, wherein said Lennard-Jones parameters relate to surface and interface properties, and wherein the Lennard-Jones parameters deviate less than between 1% and 20%. A means of preparing input data for said molecular models is used and a means of importing prepared data for the molecular models is provided. A means of selecting force field type and functional forms, and assigning atom types to said molecular models is provided and means of providing force field parameters for molecular models based on the molecular models are provided. The system further includes means of exporting the force field parameters in predetermined formats to at least one external molecular mechanics simulation package and saving the molecular models, input data and force field parameters to a database.

The Lennard-Jones parameters for fcc metals have been developed which are suitable for the simulation of the metals, alloys, and interfaces with water, organic, inorganic, and biological molecules. The models are compatible with common materials-oriented and biomolecular force fields, and can thus be easily integrated in commercial simulation packages to extend their applicability to any metal-related systems. An advantage of these models over earlier available models is the improvement in surface and interface properties, which typically deviate less than between 1% and 20% relative to experiment as opposed to between 1% and 500% in various earlier models.

The invention also puts forward a general methodology to parameterize such models, which consists of the adjustment of the two parameters r₀ and ∈₀ to densities and surface tensions of the metals at a given temperature, as obtained from experimental data. This leads to very accurate and computationally very fast models, about a million times faster than using quantum-mechanical approaches.

The application of simulation techniques and methods disclosed in the invention lies in the prediction of surface energies, surface energy anisotropies, mechanical properties, adsorption energies, and self-assembly processes as relevant for the synthesis, growth and characterization of metal nanostructures (particles, rods, wires, dendrites) in precursor solutions, and in the prediction of specific adsorption of surfactants, organic molecules, and biological molecules (peptides, carbohydrates, lipids, DNA) on regular and irregular metal, bimetal, and alloy surfaces. This can be helpful for the design of new plasmonic sensors, actuators, drug delivery and therapeutic devices. Moreover, diffusion processes at metal surfaces and binding constants as predictable from the proposed model can guide in the assembly of metal-organic, metal-inorganic, and metal-biological composites.

In view of the foregoing, it is desirable to provide methods and systems that greatly enhance simulations of systems having at least one metal or biomineral constituent, and other attributes of the invention will become apparent on a reading of the following description in conjunction with the figures.

### BRIEF DESCRIPTION OF THE DRAWINGS

FIG. 1 shows the comparison of the 12-6 LJ potential and the equivalent 9-6 LJ potential (shown for Au).

FIGS. 2(a) shows a model of a cubic Au 5×5×5 super cell where {100} cleavage planes can be generated perpendicular to the three Cartesian coordinate axes, and FIG. 2(b) shows a model of an alternative orthorhombic super cell where {111} cleavage planes can be generated perpendicular to the vertical axis.

FIGS. 3(a) and 3(b) show illustrations of the calculation of the surface tension for a {111} surface using two boxes with FIG. 3(a) showing separated surfaces and FIG. 3(b) showing unified surfaces.

FIGS. 4(a)-4(c) show illustrations of the calculation of the metal-water interface tension using three boxes with FIG. 4a showing a metal-water interface, FIG. 4(b) showing pure metal, and FIG. 4(c) showing pure water.

FIG. 5(a) shows the surface tension of the {111} face of the fcc metals in experiment as well as in the simulation with the new LJ models and with the existing LJ models.

FIG. 5(b) shows the ratio of the surface tensions of the {100} face to the {111} face with the new LJ models, with experimental data indicating values between 1.03 and 1.05 but are yet uncertain for most metals (ref. 56). (c) Metal-water interface tension of the {111} face in experiment, and with the new LJ models incorporated in the CVFF and COMPASS force fields which contain SPC and SPC-like water models.

FIG. 6(a) illustrates a metal-water interface (Pb-water as an example) with the 9-6 LJ parameters according to the invention and FIG. 6(b) shows existing 9-6 LJ parameters in molecular dynamics simulation.

FIG. 7(a)-7(c) show elastic moduli of the fcc metals according to experiment, the new LJ model, and existing LJ models, with FIG. 7(a) showing Young's modulus, FIG. 7(b) bulk modulus, and FIG. 7(c) shear modulus.

### DESCRIPTION OF THE INVENTION

The invention relates to systems and methods for integration into simulation approaches in association with metals, including fcc metals or other metals such as hcp, cubic centered or other metals for example. The invention may also relate to extending to biominerals such as hydroxyapatite, silica and other possible constituents. Examples include the surfactant-directed growth of metal nanostructures as well as the selective binding of metals or biominerals to biomolecules such as peptides, and specifically designed cell surfaces to metal nanoparticles. Examples include the surfactant-directed growth of metal nanostructures as well as the selective binding of peptides, specifically designed cell surfaces or the like to metal or biomineral nanoparticles. Although the following description relates primarily to interaction with fcc metal materials, such other materials are contemplated according to the invention. The systems and methods may be implemented in software simulation packages used to assess the interaction of metals or biominerals for example, with other materials and constituents. The invention provides more accurate Lennard-Jones parameters under ambient conditions which can be used with existing force fields for the simulation of metals and hybrid interfaces using molecular dynamics and Monte Carlo methods for example. Molecular dynamics and Monte Carlo simulations often rely on Lennard-Jones (LJ) potentials for nonbond interactions. As set forth hereafter, 12-6 and 9-6 LJ parameters for several fcc metals (Ag, Al, Au, Cu, Ni, Pb, Pd, Pt) are determined which reproduce densities, surface tensions, interface properties with water and (bio)organic molecules, as well as mechanical properties in quantitative (<0.1%) to good qualitative (25%) agreement with experiment under ambient conditions. Deviations associated with earlier LJ models have been reduced by at least one order of magnitude due to the precise fit of the new models to densities and surface tensions under standard conditions, which also leads to significantly improved results for surface energy anisotropies, interface tensions, and mechanical properties. The performance is comparable to tight-binding and embedded atom models at up to a million times lower computational cost. The models extend classical simulation methods to metals and a variety of interfaces with biopolymers, surfactants, and other nanostructured materials through compatibility with widely used force fields, including AMBER, CHARMM, COMPASS, CVFF, OPLS-AA, and PCFF.

Two common functional forms of the Lennard-Jones (LJ) potential have been in use in prior simulations. LJ potentials are often used in the 12-6 form and in the 9-6 form,

$$\begin{matrix}E = {ɛ}_{0} [ {( \frac{{r}_{0}}{r} )}^{12} - 2 {( \frac{{r}_{0}}{r} )}^{6} ] = \frac{A}{{r}^{12}} - \frac{B}{{r}^{6}} \\ ( with A = {ɛ}_{0} {r}_{0}^{12} , B = 2 {ɛ}_{0} {r}_{0}^{6} , {r}_{0} = \sqrt[6]{\frac{2 A}{B}} ) & ( 1 ) \\ E = {ɛ}_{0} [ 2 {( \frac{{r}_{0}}{r} )}^{9} - 3 {( \frac{{r}_{0}}{r} )}^{6} ] . & ( 2 )\end{matrix}$$

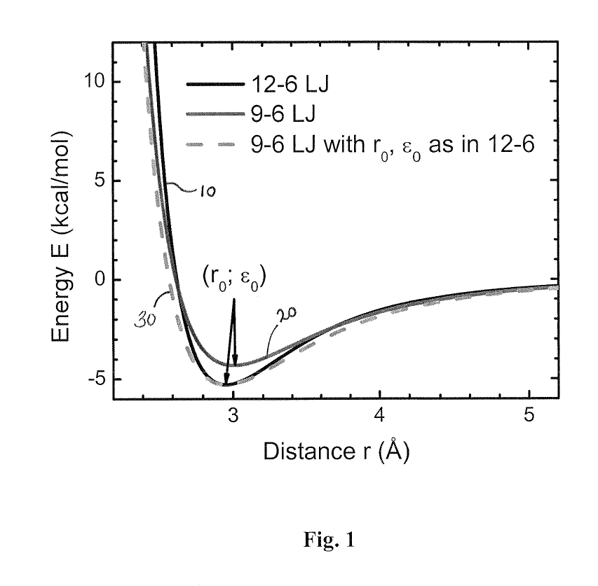

In Equations (1) and (2), ∈₀ represents the equilibrium non-bond energy and r₀ the equilibrium non-bond distance between two atoms of the same type. As shown in FIG. 1, which is a comparison of the 12-6LJ potential and the equivalent 9-6 LJ potential for one fcc metal (Au). FIG. 1 also shows the effect when the values of r₀ and ∈₀ in the 12-6 potential would be transferred without modification to the 9-6 potential, wherein the computed density and the computed surface energy would increase. In mixtures with other elements or compounds, the parameters ∈_{0,ij} and r_{0,ij} for non-bond interactions between different atom types i and j can be obtained by combination rules as discussed hereafter.

Equations (1) and (2) show that every pure fcc metal is characterized by only two adjustable parameters r₀ and ∈₀ in the LJ model which physically represent the density and the surface free energy at a given point in the phase diagram. This interpretation of the parameters is justified (1) by the density as a volumetric quantity and (2) by surface properties as an essential driving force in self-assembly processes at interfaces. It is therefore desirable to reproduce both quantities as accurately as possible. Moreover, (3) LJ models as well as many other molecular models cannot cover a temperature range of several thousand Kelvin (boiling points of metals) and extreme pressure without adjustments to the parameters. Therefore, a reference state is necessary, and as described hereafter, ambient conditions have been chosen as the reference state, with a temperature of 298.15 K and a pressure of 101.325 kPa as a reference point to experiment, which is suitable for many condensed matter applications and compatible with various force fields. The rationale of this approach has been accepted in a more general form including charged systems and relates to the accurate parameterization of force fields of inorganic as well as organic solids.

This strategy to derive LJ parameters for metals differs from common approaches for nonpolar organic liquids. In one such approach, computed densities and vaporization energies (cohesive energies) are brought in agreement with experimental data. If the boiling point lies approximately within ±200 K of room temperature, the well reproduced cohesive energy in the model for the liquid also leads to surface and interface properties in good agreement with experiment under ambient conditions because LJ parameters typically perform reliably in this temperature range without further adjustments. Although useful for nonpolar organic liquids, the approach cannot be applied to metals and minerals, because high melting and boiling points up to 4000 K exceed the acceptable temperature range near 298 K by more than an order of magnitude. Thus, vaporization energies are not suitable to parameterize a LJ model for metals at room temperature. In another strategy for nonpolar liquids, critical points in experimental phase diagrams, such as temperature vs density, are considered as reference points to assign LJ parameters. This approach is also not suitable for fcc metals at room temperature because the reference state is strongly substance-dependent and located in regions of the phase diagram up to 8000 K.

From this, it is concluded that the density and the surface tension under standard conditions are suitable reference points to experiment. The accurate representation of the density, mainly determined by r₀, and of the surface free energy for the lowest energy {111} face, mainly determined by ∈₀, increases the reliability of existing LJ parameters by an order of magnitude in comparison to parameterizations that rely on the density and on the vaporization energy. For example, the resulting model LJ model for fcc metals is also capable of the nearly quantitative analysis of surface energies of other crystal faces as well as interfacial energies with water and (bio)organic molecules. Elastic moduli can be computed in ±20% agreement with experiment using 12-6 LJ parameters and with −35% systematic deviation from experiment using 9-6 LJ parameters, down from deviations of up to several multiples otherwise, as will be described hereafter.

The invention therefore provides new approaches to assign Lennard-Jones parameters because earlier LJ parameters for metals and combinations of LJ parameters with many-body terms relied on vaporization energies at 2000 K to 4000 K for the assignment of ∈₀, and considerable difficulties to bring cohesive energies, surface energies, and elastic moduli in agreement with experiment at room temperature were consequently reported. The discrepancy between computed versus measured surface and mechanical properties reached multiples relative to experiment, and it was assumed that alternative models may hold more promise, even though EAM models exhibit deviations in surface tensions on the order of 50%. As a result, most force fields do not contain LJ parameters for elemental metals and some force fields (CVFF, PCFF, COMPASS) contain parameters which have undergone empirical refinement over time. The poor performance of the existing LJ models in simulating fcc metals at room temperature was associated with unsuitable reference states at 2000 K to 4000 K and ambiguity in the physical interpretation. The invention therefore suggests the revision of prior conclusions on the suitability of LJ parameters for the simulation of fcc metals. The invention in one aspect provides a method of deriving Lennard-Jones potentials for metal materials. The method comprises the steps of determining the values of at least density and surface tension at a predetermined temperature for a predetermined metal. Such values may also be determined at a predetermined pressure. The values of at least density and surface tension are translated into first estimates of at least the two parameters r₀ and ∈₀ of a Lennard-Jones model. The density and surface tension is computed using the first estimates in a NPT and/or NVT molecular dynamics simulation. Thereafter, the computed density and surface tension is used to derive at least second estimates of said at least two parameters r₀ and ∈₀ to adjust the values of said at least two parameters r₀ and ∈₀. The density and surface tension are then computed using the second estimates in a NPT and/or NVT molecular dynamics simulation, and it is determined if the second estimates provide predetermined results from the computation. If predetermined results are not provided, the steps can be repeated to derive third or more estimates of the at least two parameters r₀ and ∈₀ until predetermined results from the computation in a NPT and/or NVT molecular dynamics simulation are provided, to yield Lennard-Jones potentials for use in simulations in association with a predetermined metal. The derived LJ potentials for different fcc metals are shown in Table 1.

The invention also provides integration into existing force fields using combination rules. The two parameters r₀ and ∈₀ can be directly implemented in force fields which use a LJ potential and will lead to the same computed equilibrium density and surface tension of cleavage planes of the pure fcc metals. In addition, combination rules to derive the parameters ∈_{0,ij} and r_{0,ij} for non-bond interactions between different atom types i and j offer a convenient pathway to unite the LJ parameters for fcc metals with a broad range of existing parameters for inorganic, organic, and biological compounds for the simulation of hybrid materials and interfaces. A condition for a successful combination hereby is the quality of the parameters for the added inorganic and (bio)organic species though, in addition, the suitability of combination rules also may play a role. The influence of combination rules on the results is typically minor, however, it is clear that combination rules between any atom types are approximations. Therefore, the invention summarizes the possible factors which have an influence in the simulation of hybrid systems and state our assumptions. (1) Actual force field parameters are approximations and can differ from one force field to another, such as different water models (SPC, TIP3P, and TIP5P). Even when combination rules and 1-4 scaling are identical, differences in force field parameters will change the computed properties of metal interfaces in proportion to the difference in parameters. Besides, the application of inadequately short cutoffs (10 Å) and coarse treatments of Coulomb interactions leads to different results, which can be avoided and are not considered further. (2) The invention also assumes a geometric mean for the 12-6 potential, r_{0,ij}=\sqrt{r_{0,ii}r_{0,jj}} and ∈_{0,ij}=\sqrt{∈_{0,ii}E_{0,jj}}, as in AMBER, CVFF, and OPLS-AA, as well as a 6th power combination for the 9-6 potential,

$${r}_{0 , ij} = \sqrt[6]{\frac{{r}_{0 , ii}^{6} + {r}_{0 , jj}^{6}}{2}} and {ɛ}_{0 , ij} = \sqrt{{ɛ}_{0 , ii} {ɛ}_{0 , jj}} \frac{2 {r}_{0 , ii}^{3} {r}_{0 , jj}^{3}}{{r}_{0 , ii}^{6} + {r}_{0 , jj}^{6}} ,$$

as in COMPASS and PCFF. In a system with multiple atom types characterized by sets of parameters r₀ and ∈₀, a change in combination rules thus leads to different total energy. As an example, the 12-6 LJ potential of CHARMM calculates r_{0,ij} as an arithmetic mean r_{0,ij}=(r_{0,ii}+r_{0,jj})/2 and employs the same geometric mean as in AMBER, CVFF, and OPLS-AA ∈_{0,ij}=\sqrt{∈_{0,ii}∈_{0,jj}} which causes a difference, albeit it is likely small. The quality of combination rules may be improved to a certain extent, however, actual validation has been limited to relatively few systems and mostly resulted in quantitative and semi-quantitative agreement with experiment. (3) Scaling schemes for nonbond interactions between 1-4 bonded atoms can have a remote impact on the energies of metal-hybrid interfaces since ideal values for r₀ and ∈₀ for atoms with covalently bonded 1,4 connections depend on the extent of scaling of the 1-4 nonbond interactions (100%, 50%, etc) in the force field and affect the interaction with metal surfaces by means of combination rules. (4) Polarization effects also play a role on metal surfaces, as will be described hereafter.

In general, the LJ parameters for fcc metals are derived independent from combination rules and from scaling of nonbond interactions between 1,4 bonded atoms since the validation involves only properties of the pure metal and only nonbond interactions. The incorporation of the LJ parameters in different force fields thus leads to the same density and surface tension of the fcc metals. Interfacial interactions with other metals, inorganics, and bio(organic) molecules depend on the quality of the force field parameters for these moities, the suitability of given combination rules and 1-4 scaling conventions, as well as on polarization effects. In the invention as described, the approach is limited to the two independent combination rules for CVFF and COMPASS (PCFF) for initial validation, which both demonstrate good compatibility with the LJ parameters for the metals and improvements in interfacial energies up to an order of magnitude compared to previous parameters, but it is contemplated that other effects of combination rules and 1,4 scaling can be performed.

The invention provides a new LJ model for fcc metals wherein the approach is validated by experimentally determined densities and surface tensions of the low energy {111} surface are employed for the assignment of the parameters r₀ and ∈₀ in the new LJ model at 298 K under atmospheric pressure. The two parameters exhibit only minor interdependence in the final fit which reflects the physically distinct roles. The new parameters are listed in Table 1 below for the 12-6 and for the 9-6 LJ potentials, with prior values in brackets adjacent the new values. The values were derived from a least-square fit, the number of significant digits is limited to computational accuracy within experimental uncertainty, and the models are valid within a temperature range of 298 K±200 K. The comparison of 12-6 parameters and corresponding 9-6 parameters shows a systematic increase in r₀ by ˜1.7% and a decrease in ∈₀ by ˜18% in the 9-6 potential which compensates for weaker repulsion and stronger attraction in the 9-6 potential, see FIG. 1.

This approach is very efficient since surface and interface properties of the metals determine the interaction with other components and are taken into account with the highest possible accuracy. In the model, the metal consists of charge-neutral atoms with repulsive and dispersive van-der-Waals interactions according to equations (1) or (2), respectively. Modifications for other temperatures (and pressures) are possible by adjustment of r₀ and ∈₀. Experimental values for the density and for the surface tension at a different temperature can be utilized to obtain refined parameters.

TABLE 1

| | 12-6 Lennard Jones Potential | | | | 9-6 LJ Potential | |
|---|---|---|---|---|---|---|
| | (AMBER, CHARMM, CVFF, OPLS-AA)^{a} | | | | (COMPASS, PCFF)^{b} | |
| Metal | r₀ (A) | ε₀ (kcal/mol) | A $( \frac{kcal}{mol} \cdot {Å}^{12} )$ | B $( \frac{kcal}{mol} \cdot {Å}^{6} )$ | r₀ (Å) | ε₀ (kcal/mol) |
| Ag | 2.955 | 4.56 | 2021000 | 6072 | 3.005 | 3.73 |
| | [2.9678] | [7.951] | [3712100] | [10865.5] | [3.0222] | [4.1002] |
| Al | 2.925 | 4.02 | 1577000 | 5035 | 2.976 | 3.26 |
| | [2.9409] | [9.043] | [3784320] | [11699.8] | [2.9964] | [3.3232] |
| Au | 2.951 | 5.29 | 2307000 | 6987 | 3.003 | 4.32 |
| | [2.9599] | [10.18] | [4603940] | [13692] | [3.0177] | [6.098] |
| Cu | 2.616 | 4.72 | 484800 | 3026 | 2.661 | 3.84 |
| | [2.6243] | [9.439] | [1007210] | [6166.7] | [2.6775] | [3.8187] |
| Ni | 2.552 | 5.65 | 431100 | 3121 | 2.598 | 4.59 |
| | [2.5615] | [11.983] | [955901.7] | [6768.92] | [2.6105] | [5.0737] |
| Pb | 3.565 | 2.93 | 12350000 | 12030 | 3.622 | 2.47 |
| | [3.5885] | [5.451] | [24856900] | [23280.5] | [3.6541] | [34.186] |
| Pd | 2.819 | 6.15 | 1549000 | 6173 | 2.868 | 5.03 |
| | [2.8286] | [9.839] | [2581170] | [10078.9] | [2.8810] | [6.0846] |
| Pt | 2.845 | 7.80 | 2193000 | 8272 | 2.896 | 6.38 |
| | [2.8533] | [9.1447] | [4576820] | [16963.3] | [2.9034] | [9.1447] |

^{a}Eq. (1).
^{b}Eq. (2).

For the evaluation of the new and existing LJ models, the densities, surface tensions of the {111} and {100} faces, interface tensions with water, and isotropic elastic constants were computed. The computational procedures are outlined in the following.

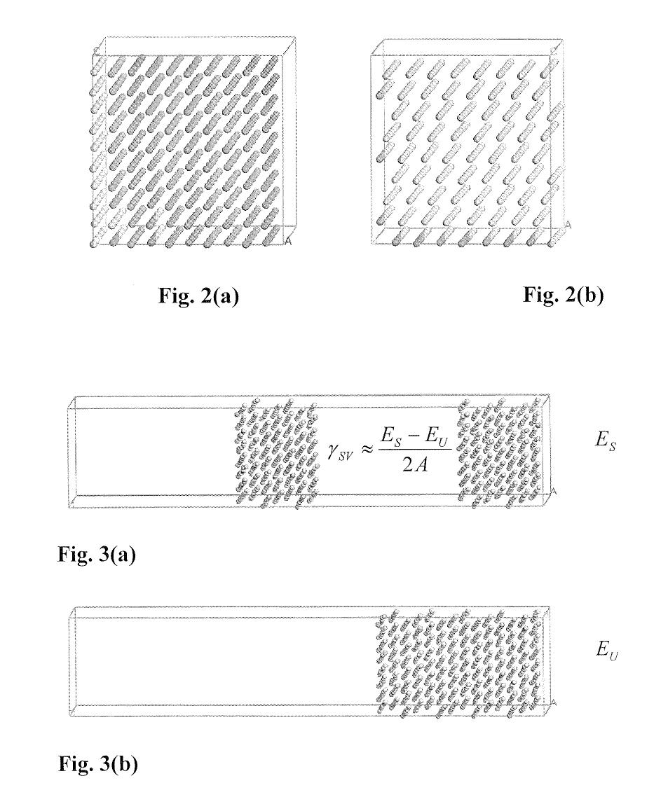

In accordance with describing aspects of the invention, experimental models of the face centered cubic (fcc) metals were constructed using lattice parameters derived from X-Ray data. Super cells of approximately 2×2×2 nm³ size (5×5×5 unit cells) were employed to compute the equilibrium density using NPT molecular dynamics simulation under standard conditions, with an example for Au shown in FIG. 2(a). Atmospheric pressure was maintained by the Parrinello-Rahman barostat with an isotropic stress of −0.1 MPa, the temperature was controlled at 298.15 K, and a spherical cutoff of Lennard-Jones interactions at 1.2 nm was employed, see section regarding visualization and calculation below. Changes in the trajectory were minimal after 100 ps, and an additional simulation time of 500 ps was sufficient to compute the average density with <0.1% deviation. As seen in FIG. 2(a), the model of a cubic Au 5×5×5 super cell is shown. In this model, the {100} cleavage planes can be generated perpendicular to the three Cartesian coordinate axes. In FIG. 2(b), a model of an alternative orthorhombic super cell is shown, with the {111} cleavage planes can be generated perpendicular to the vertical axis.

As seen in FIG. 2 the models of {111} and {100} cleavage planes were prepared from suitable super cells. Metal-vapor surface tensions γ_{SV} were computed on the basis of two NVT simulations, using models with and without two additional surfaces as shown in FIGS. 3(a) and 3(b). The box dimensions correspond to multiples of the experimental cell parameters (FIG. 2). A uniform metal slab of ˜4 nm thickness and a vacuum slab of ˜8 nm represent a unified surface; two separated metal slabs of half the thickness (˜2 nm) and half the separation (˜4 nm) represent a separated surface (FIG. 3). Each of the two boxes was of the same dimensions for a given metal, contained the same total number of atoms, and was subjected to NVT molecular dynamics simulation at 298.15 K for 500 ps (FIG. 3). The difference in average total energy between the separated structure E_{S} and the unified structure E_{U} equals the cleavage energy per surface area 2A, and the surface tension μ_{SV} follows as:

$${γ}_{SV} = \frac{{E}_{S} - {E}_{U}}{2 A} - T \frac{{S}_{S} - {S}_{U}}{2 A} \approx \frac{{E}_{S} - {E}_{U}}{2 A} . \qquad ( 3 )$$

The entropy contribution

$$- T \frac{{S}_{S} - {S}_{U}}{2 A}$$

is negligible compared to the cohesive energy contribution

$$\frac{{E}_{S} - {E}_{U}}{2 A}$$

in the metals, supported by minor oscillations of the metal atoms around their lattice points in the bulk and at the cleaved surfaces. Without approximation, the surface tension was also computed using the average in-plane pressure component p_{∥}=(pₓₓ+p_{yy})/2, the average vertical pressure component p_{⊥}=p_{zz}, and the vertical extension z₀ of the box during molecular dynamics simulation of the unified structure (FIG. 3b):

$${γ}_{SV} = \frac{( {p}_{⊥} - {p}_{∥} ) {z}_{0}}{2} . \qquad ( 4 )$$

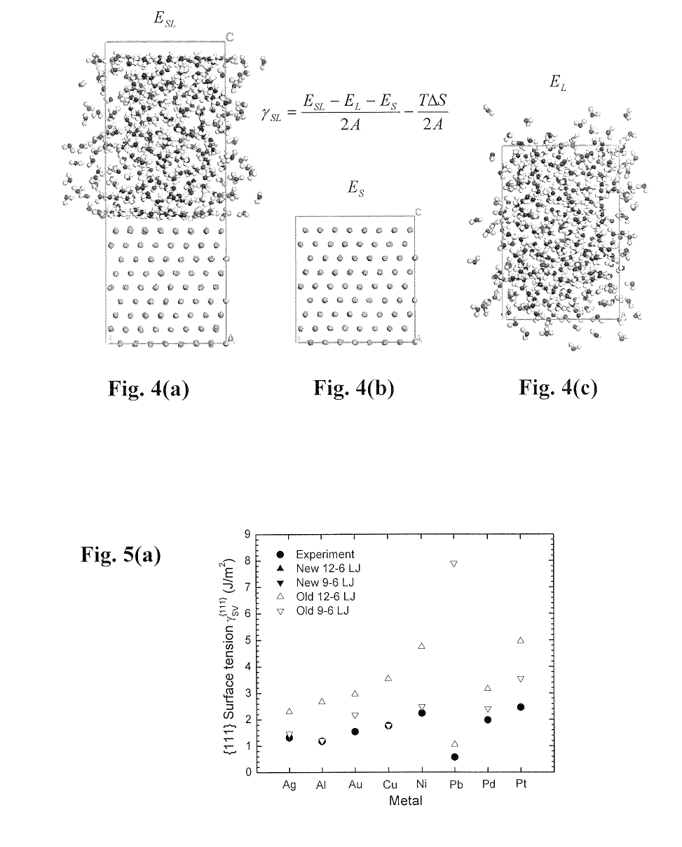

This method requires rather lengthy simulations to compute precisely p_{∥} and p_{⊥}, nevertheless, results from Eq. (3) and Eq. (4) were identical within ±10 mJ/m².
Metal-water interface tensions γ_{SL}^{{111}} were computed similarly on the basis of three NVT simulations, with reference to FIG. 4. FIG. 4 shows illustrations of the calculation of the metal-water interface tension using three boxes, wherein FIG. 4(a) shows a metal-water interface, FIG. 4(b) shows pure metal and FIG. 4(c) showing pure water. A metal super cell of ˜2 nm thickness with water molecules added onto the lowest energy {111} cleavage plane along the z coordinate represents the metal-water (SL) interface, a separate water slab of ˜3 nm thickness represents the pure water (L), and a separate metal slab of ˜2 nm thickness represents the pure metal (S) (as seen in FIG. 4). All cells are based on multiples of the experimental cell parameters for the metal, a water density of 1 g/cm³, and were subjected to NVT molecular dynamics simulation at 298.15±0.01 K for 500 ps. The SPC water model in CVFF (12-6 LJ potential) and an SPC-like water model in COMPASS (9-6 LJ potential) were employed using the combination rules described above. The difference in average energies E_{SL}, E_{L}, and E_{S} yields the interfacial energy

$$\frac{{E}_{SL} - {E}_{L} - {E}_{S}}{2 A} ,$$

and the interface tension follows as:

$${γ}_{SL} = \frac{{E}_{SL} - {E}_{L} - {E}_{S}}{2 A} - T \frac{{S}_{SL} - {S}_{L} - {S}_{S}}{2 A} . \qquad ( 5 )$$

The entropy contribution

$$( - T \frac{{S}_{SL} - {S}_{L} - {S}_{S}}{2 A} )$$

arises from the first layer of partially immobilized, superficial water (FIG. 4) and was estimated from the melting enthalpy of ice (6.01 kJ/mol) at 273.15 K. This corresponds to an entropy of freezing ΔS=−22 J/(mol·K), and one layer of “frozen” water molecules on the metal surface in contact with water (45 molecules cover an area of ˜4 nm²) leads to an entropy contribution +0.12 J/m². Due to significant residual mobility of this water layer during the simulation, unlike the frozen state, we assume an entropy contribution of +0.06±0.03 J/m² in Eq. (5), equal to 50% of the total value. Without approximations, the interface tension for the metal-water box (FIG. 4a) was also computed from Eq. (4) using more time-consuming calculations, and yields the same results as Eq. (5) within ±0.03 J/m². Polarization on the metal surface was not assumed for evaluation of the results and comparison with experiment as set forth below. Though the interface tension as shown relates to the metal-water interface, the interface tension with other materials or constituents may be evaluated similarly.

Evaluation of elastic moduli was also performed. The isotropic elastic constants Young's modulus E, bulk modulus K, shear modulus G, and the Poisson ratio ν were computed by static, dynamic, and fluctuation approaches using a cubic supercell as shown in FIG. 2a. The static and the fluctuation approach yield the same moduli E and K within ±1% to ±5% deviation using small strain in agreement with the definition, while large strain between 0.0 and 0.2 in the dynamic approach results in approximately +10% larger moduli. Results are quoted for the static and for the fluctuation approach at small strain. The values are identical to those derived from NPT simulation with a tensile stress σ=−pₓₓ between ±0.1 GPa and ±1 GPa along the x axis to calculate E=E_{XX} (all other stresses zero) and with an isotropic stress σ=−pₓₓ=−p_{yy}=−p_{zz}, between ±0.1 GPa and ±1 GPa to calculate K. The reproducibility of the elastic moduli is within ±1% to ±5%.

Visualization and calculations were performed using Materials Studio, the Discover program, and LAMMPS. The simulation protocol for NVT molecular dynamics involved the Verlet integrator, a 12 Å cutoff for van-der-Waals interactions, Ewald summation with high accuracy (2.5·10⁻⁵ kcal/mol) for Coulomb interactions in the case of the solid-liquid interface, and a time step of 1 fs. The temperature was controlled with the Andersen thermostat (collision frequency between 0.05 and 1.0) at 298.15 K in Discover, and with the Nose-Hoover thermostat in LAMMPS. An increase of the vdW cutoff from 12 Å to 15 Å resulted in a <1% increase in computed solid-vapor interface energies and a negligible change in density. Pressure control in NPT simulation was maintained using the Parrinello-Rahman barostat.

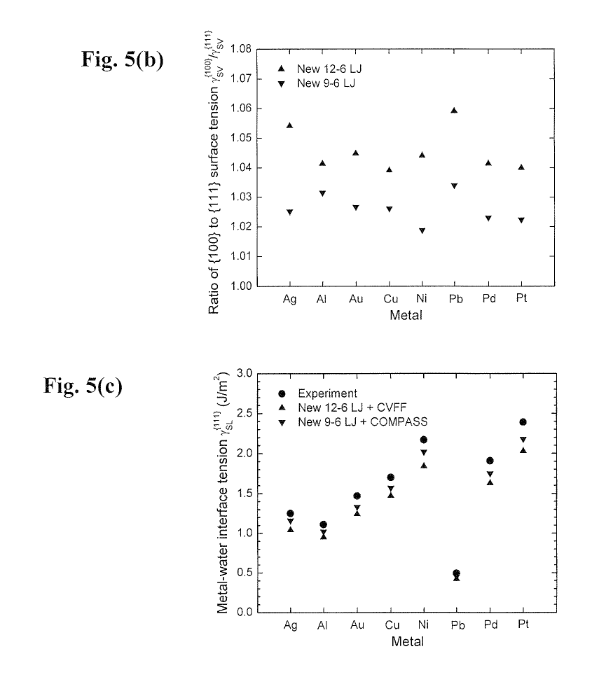

Based on these evaluations, the results were compared with experiment, with the densities, surface tensions of the {111} and the {100} face, interface tensions with water, and the isotropic elastic constants obtained in the computation using the new 12-6 and 9-6 LJ parameters in comparison with experiment, existing LJ parameters, and other models. The data are presented in Tables 2, 3, 4, 5, as well as in FIGS. 5, 6, and 7. We consider the current parameter sets in the CVFF (“Old 12-6”) and PCFF/COMPASS (“Old 9-6”) force fields as existing parameters for the fcc metals, which have been empirically somewhat improved as compared to prior art.

Computed cell parameters (Table 2 below) and, consequently, the densities of the fcc metals are in quantitative agreement with experiment using both new and existing LJ models. The two parameters r₀ and ∈₀ have been fitted to the density according to the model of the present invention and in earlier models, as one of the two available reference points for each metal, so that the agreement between experiment and simulation is expected. A small difference of −1% between the computed and the experimental density (Δp˜[1−(1−Δa/a)³]) in the existing 9-6 LJ parameters is reduced to <0.1% in the new model according to the invention.

TABLE 2
Cell parameters for a (5 × a)³ super cell in experiment
and in the simulation (in Å).

| Metal | Expt^{a} | New 12-6 | New 9-6 | Old 12-6^{b} | Old 9-6^{c} |
|---|---|---|---|---|---|
| Ag | 20.4285 | 20.434 | 20.427 | 20.470 | 20.528 |
| Al | 20.248 | 20.244 | 20.249 | 20.275 | 20.386 |
| Au | 20.391 | 20.389 | 20.391 | 20.452 | 20.455 |
| Cu | 18.073 | 18.080 | 18.072 | 18.085 | 18.185 |
| Ni | 17.620 | 17.620 | 17.621 | 17.640 | 17.696 |
| Pb | 24.751 | 24.762 | 24.750 | 24.813 | 24.719 |
| Pd | 19.4515 | 19.461 | 19.452 | 19.495 | 19.521 |
| Pt | 19.618 | 19.622 | 19.620 | 19.646 | 19.646 |
| Stddev to Expt | ±0.001 | ±0.007 | ±0.001 | ±0.043 | ±0.091 |

^{a}Ref. 46.
^{b}CVFF.
^{c}COMPASS and PCFF

The most significant improvement of the models are the surface and interface energies. Solid-vapor interface tensions for the {111} faces are quantitatively fitted to experimental values with less than 1% deviation (Table 3 and FIG. 5a). In FIG. 5(a) the surface tension of the {111} face of the fcc metals is shown in experiment as well as in the simulation with the new LJ models and with the existing LJ models. However, some experimental values for the {111} surface tension are uncertain in a ±5% range so that the LJ model is of the same ±5% reliability in these cases. Existing LJ parameters perform poor relative to experiment in most (but not all) cases, showing deviations up to several 100% (FIG. 5a). In comparison to the LJ model, tight-binding and embedded atom (EAM) models are associated with typical deviations in surface energies of 15% and 50% to experiment, respectively, as well as computationally much more costly. Sometimes, even errors of multiples were reported. Therefore, the new LJ model performs excellent in comparison to existing LJ models, EAM models, and even tight-binding methods.

For the {100} face, computed surface tensions are on average 4.5% or 2.6% higher than for the {111} face using 12-6 or 9-6 LJ potentials, respectively (Table 3 and FIG. 5b). In FIG. 5(b), there is shown the ratio of the surface tensions of the {100} face to the {111} face with the new LJ models. Experimental data indicate values between 1.03 and 1.05 but are yet uncertain for many metals. Experimental measurements of the surface energy anisotropy indicate that surface tensions of {100} faces are approximately 3% to 5% higher relative to {111} faces, in support of the LJ model. However, the analysis of equilibrium nanoparticle shapes and the associated deduction of the anisotropy of the surface tension can be associated with some error so that experimental data are yet a semi-quantitative guide. The differences in surface tension between the {100} and {111} faces in the LJ model indicate a relation between the geometry of the metal surface and the surface energy, even though a dependence on the type of LJ potential is also seen.

TABLE 3
The solid-vapor surface tension γ_{SV}^{{111)} and γ_{SV}^{{100}}
in experiment and in the simulation (in J/m²).

| | γ_{SV}^{{111}} | | | | | γ_{SV}^{{100}} | | |
|---|---|---|---|---|---|---|---|---|
| | | New | New | Old | Old | | New | New |
| Metal | Expt^{a} | 12-6 | 9-6 | 12-6^{c} | 9-6^{d} | Expt | 12-6 | 9-6 |
| Ag | 1.32^{b}-1.19 | 1.312 | 1.310 | 2.302 | 1.467 | 3-5% | 1.383 | 1.343 |
| Al | 1.18^{b}-1.10 | 1.185 | 1.176 | 2.671 | 1.204 | higher | 1.234 | 1.213 |
| Au | 1.54^{b}-1.48 | 1.540 | 1.539 | 2.963 | 2.174 | than | 1.609 | 1.580 |
| Cu | 1.77 ± 0.02^{b} | 1.767 | 1.761 | 3.540 | 1.772 | γ₍₁₁₁₎^{SV} | 1.836 | 1.807 |
| Ni | 2.24 ± 0.02^{b} | 2.225 | 2.234 | 4.744 | 2.486 | (absolute | 2.323 | 2.276 |
| Pb | 0.567 ± 0.01 | 0.558 | 0.559 | 1.048 | 7.896 | values not | 0.591 | 0.578 |
| Pd | 1.98 ± 0.02 | 1.980 | 1.994 | 3.166 | 2.410 | known)^{e} | 2.062 | 2.040 |
| Pt | 2.46 ± 0.03 | 2.455 | 2.459 | 4.960 | 3.547 | | 2.553 | 2.514 |
| Stddev | ±0.06 | ±0.008 | ±0.008 | ±1.79 | ±2.82 | | +4.5% | +2.6% |

| | |
|---|---|
| To Expt | rel. to {111} |

^{a}All values Tyson, W. R.; Miller, W. A. Surf. Sci. 1977, 62, 267-276.
^{b}Direct measurement at 298 K, given in Tyson, W. R.; Miller, W. A. Surf. Sci. 1977, 62, 267-276. The remaining values are extrapolated from different temperatures, with the stated reliability.
^{c}CVFF.
^{d}COMPASS and PCFF. The identity of PCFF parameters and COMPASS parameters for the eight metals under consideration was shown using single point energy calculations. Numerical equivalence of the energies using PCFF and COMPASS was found up to all post-comma digits for arbitrary assemblies of atoms.
^{e}See (a) Menon, S. K.; Martin, P. L. Ultramicroscopy 1986, 20, 93-98, wherein the authors explain that the particle shape in earlier studies of the surface energy anisotropy was influenced by substrate-condensate interactions. Thus, ratios between the {110} and {111} surface tensions of 1.03 to 1.15 in earlier reports actually range from 1.01 to 1.04 for {100} vs {111} surfaces and for {110} vs {111} surfaces when such interferences are eliminated. (b) Flueli, M.; Borel, J. P. J. Cryst. Growth 1988, 91, 67-70. Ratios between the {100} and the {111} surface energy for Au near 1.05 are reported, (c) Lee, W. H.; Vanloon, K. R.; Petrova, V.; Woodhouse, J. B.; Loxton, C. M.; Masel, R. I. J. Catal. 1990, 126, 658-671. The relative energy of Pt {100} and {111} surfaces was examined under oxidative conditions (O₂) at high temperatures. While stepped surfaces and {100} surfaces were preferred under these particular conditions, relative energy differences between {100} and {111} faces are generally identified as ~4%. (d) Girin, O. B.; Vorob'ev, G. M. Russian Metallurgy 1992, 6, 90-98. A broken bond model is employed to derive generic surface energy anisotropies in fcc metals. The resulting the ratio of 1.106 for {100} vs {111} surface tensions, however, appears too high in comparison to experiment (a-c).

The new LJ model also was evaluated relative to interface tension characteristics. Experimental findings indicate that polar and nonpolar liquids wet clean metal surfaces with contact angles of 0°.^{57,58} Computed metal-water interface tensions in Table 4 below, show a good fit with experimental values, although some of the accuracy is compromised in comparison to pure metal surfaces as noted in FIG. 5c. In FIG. 5(c), there is shown the metal-water interface tension of the {111} face in experiment, and with the new LJ models incorporated in the CVFF and COMPASS force fields which contain SPC and SPC-like water models. The LJ model for the metal is employed in conjunction with an SPC water model (CVFF) and with an SPC-like water model (COMPASS) so that polarization effects, empirical assumptions in the force field, and combination rules introduce a systematic deviation on the order of −10% relative to experiment. The difference between computation and experiment amounts to ca. −14% with the 12-6 potential and −8% with the 9-6 LJ potential (referring to Table 4). Attractive polarization due to minor charges on the even surfaces contributes approximately +0.10±0.05 mJ/m², or 5-15% of the interface tension. Thus, polarization may be the dominant contribution to offset the gap between computed and experimental interface tensions. Other contributions to the difference arise from empirical assumptions in the force field and combination rules of the LJ parameters. Similar trends are expected for interfaces with biological and organic molecules which possess surface and interface properties on a similar scale as water, in contrast to the very high surface and interface energies of metals.

Overall, the computation of interface tensions is nearly quantitative and provides evidence that meaningful simulations of interfacial interactions in metal-containing hybrid materials are feasible. The compatibility of the LJ model according to the invention with widely used force fields allows semi-quantitative simulations of metal-organic and metal-biological interfaces, and expected differences in interfacial thermodynamic properties are on the order of 10% or less versus deviations on the order of 100% with previous LJ models. In comparison to tight binding and density functional methods, the LJ models do not take electronic structure explicitly into account and cannot be applied to chemical reactions at the interface. Nevertheless, features of the electronic structure are implicitly included so that computed interfacial energies are of the same accuracy as with quantum-mechanical methods. A major advantage is that computation times are about 10⁶ times shorter compared to ab-initio methods and larger systems up to 10⁶ atoms can be simulated at time scales close to microseconds. In comparison to EAM models with 50% deviation in interfacial energies, the LJ models according to the invention are also clearly more accurate and computation times are at least 10² times shorter.

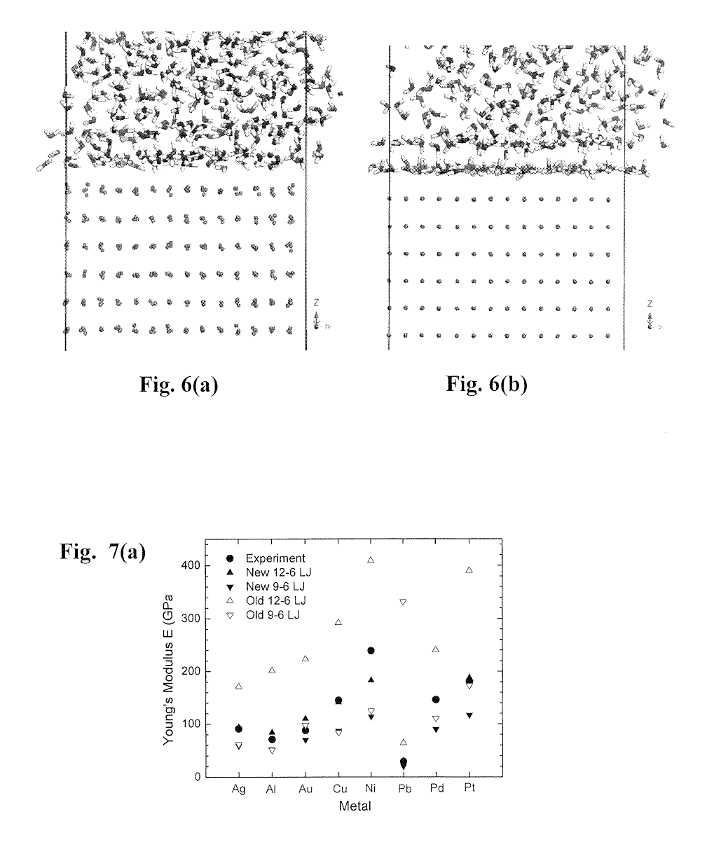

Turning to FIG. 6, there is shown an illustration to visually show the significance of accurate LJ parameters according to the invention for a non-oxidized Pb-water interface using the new and the existing 9-6 LJ potential. The new parameters shown in FIG. 6a reflect the ductility and deformability of lead (low melting point) through significant oscillation of the atoms off the lattice points in comparison with the existing model as in FIG. 6(b). FIG. 6(b) shows that when surface and interface tensions are highly overestimated, the first superficial water layer is virtually frozen and only very small oscillations of the metal atoms in the lattice are seen. The metal interface with water molecules displays weak layering and surface freezing in the accurate new model shown in FIG. 6(a) whereas strong layering and surface freezing of water is observed in the existing model with multiple times overestimated surface energy as indicated in FIG. 6(b).

TABLE 4
The solid-water interface tension γ_{SL}^{{111}} in experiment
and in the simulation (in J/m²).

γ_{SL}^{{111}}

| Metal | Expt^{a} | New, 12-6^{b} | New, 9-6^{c} |
|---|---|---|---|
| Ag | 1.25^{d}-1.12 | 1.04 ± 0.03 | 1.16 ± 0.03 |
| Al | 1.11^{d}-1.03 | 0.95 ± 0.03 | 1.02 ± 0.03 |
| Au | 1.47^{d}-1.41 | 1.24 ± 0.03 | 1.33 ± 0.03 |
| Cu | 1.70 ± 0.02^{d} | 1.47 ± 0.03 | 1.57 ± 0.03 |
| Ni | 2.17 ± 0.02^{d} | 1.84 ± 0.03 | 2.02 ± 0.03 |
| Pb | 0.494 ± 0.01 | 0.42 ± 0.03^{e} | 0.45 ± 0.03^{e} |
| Pd | 1.91 ± 0.02 | 1.63 ± 0.03 | 1.75 ± 0.03 |
| Pt | 2.39 ± 0.03 | 2.03 ± 0.03 | 2.18 ± 0.03 |
| Stddev to Expt | ±0.06 | −14% | −8% |

^{a}Experimental values for the metal-water interface tension γ^{SL} are obtained from the Young equation γ^{SL} + γ^{LV} cos θ = γ^{SV} using contact angles θ of water and of nonpolar solvents on clean metal surfaces of 0°. Accordingly, γ^{SL} is given by the metal-vapor surface tension γ^{SV} (see Table 3) and the surface tension of water γ^{LV} = 73 mJ/m² by the relation γ^{SL} = y^{SV} − γ^{LV}.
^{b}SPC water in CVFF.
^{c}SPC-like water in COMPASS (o2* and h1o).
^{d}Based on direct measurement of γ_{SL}^{{111}} at 298 K (see Table 3).
^{e}Due to the higher fluidit of the Pb-water interface in comparison to the other interfaces, an entropy correction of only +0.04 J/m² instead of +0.06 J/m² was applied (as described with reference to FIG. 4 and the evaluation of interface tension).

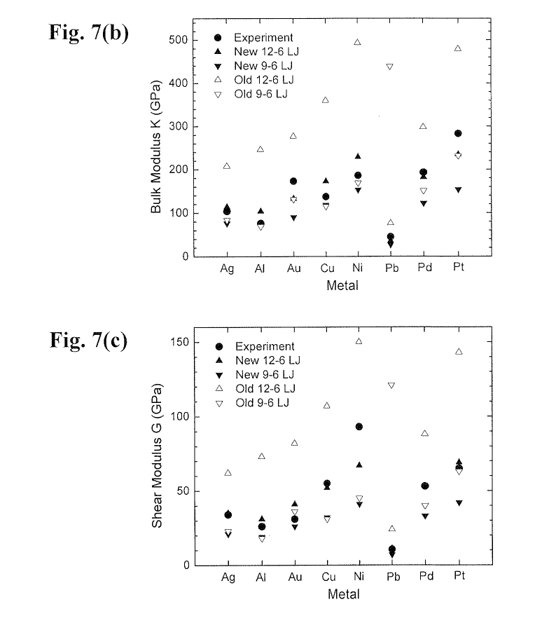

Computed isotropic elastic properties are described with reference to Table 5 and FIG. 7, and are in good qualitative agreement with experiment. The 12-6 LJ potential achieves quantitative (Pd, Ag) to good qualitative agreement with experiment with typical deviations of ±20% in elastic moduli. The 9-6 Lennard-Jones potential leads to systematic, fairly uniform underestimates of elastic moduli by approximately −35%. The agreement of computed Poisson ratios with experiment is near-quantitative using both models. Experimental Poisson ratios ν for the fcc metals range between 0.29 and 0.42 while the LJ potentials consistently yield ν close to 0.36 in the 12-6 form and close to 0.37 in the 9-6 form (Table 5). The agreement of computed elastic moduli with experiment increases when ν_{LJ}≈ν_{Metal}. Overall, the difference between the 12-6 LJ potential and the 9-6 LJ potential illustrates a better suitability of the 12-6 LJ potential to describe mechanical responses of metals and related hybrid interfaces. The improvement of the new Lennard-Jones parameters compared to earlier LJ models is significant, demonstrated by the reduction of the significant scatter including overestimates of elastic moduli up to several 100% as well as underestimates (FIG. 7). The increased reliability is associated with the reproduction of surface tensions as one of two reference points for each metal in the parameterization of the new LJ model.

It is also noted that absolute agreement between experimental values among different sources cannot be reached although the discrepancies do not exceed 5%. Reference has been made to commonly accepted values of the elastic constants C₁₁, C₁₂, C₄₄ and elastic moduli E, K, G, ν in experiment (Table 5 and FIG. 7). In this context, it is useful to recall that fcc metals can be considered as isotropic elastic solids. Thus, (1) the bulk modulus is obtained as K=(C₁₁+2C₁₂)/3, (2) the shear modulus is given as a Voigt average of a single crystal over all space G=(C₁₁−C₁₂+3C₄₄)/5, (3) the Poisson ratio follows as ν=(3K−2G)/(6K+2G), and (4) Young's modulus amounts to E=9KG/(3K+G). Only two of the four values E, K, G, and ν are independent from each other, and similar useful relations such as K=E/[3(1−2ν)] and G=E/(2+2ν) between the isotropic elastic constants can be employed.

The new LJ model performs comparable to tight-binding models which are associated with ˜20% deviations in elastic moduli. Significantly lower deviations of only ˜1% relative to experiment can be achieved using EAM potentials which include additional adjustable parameters to fit the elastic constants. In contrast, many-body potentials without additional terms to fit elastic constants have resulted in more than 100% deviation. Therefore, the reliability of elastic constants in the 12-6 LJ model is indeed very good (and in the 9-6 LJ model, acceptable), taking into account the simplicity, high computational efficiency, and compatibility with inorganic as well as (bio)organic force fields.

TABLE 5
The isotropic elastic constants E (in GPa), K (in GPa),
G (in GPa), and v in experiment and in the simulation.

| | Young's Modulus E | Bulk Modulus K | Shear Modulus G | Poisson Ratio v |
|---|---|---|---|---|
| Metal | Expt,^{a} 12-6, 9-6 | Expt,^{a} 12-6, 9-6 | Expt,^{a} 12-6, 9-6 | Expt,^{a} 12-6, 9-6 |
| Ag | 91.3, 94, 59 | 104, 114, 76 | 33.7, 35, 21 | 0.337, 0.36, 0.37 |
| Al | 70.7, 84, 52 | 75.9, 104, 69 | 26.3, 31, 19 | 0.345, 0.365, 0.375 |
| Au | 88.0, 110, 70 | 173, 133, 90 | 31.1, 41, 26 | 0.415, 0.36, 0.37 |
| Cu | 145, 141, 87 | 137, 173, 118 | 54.9, 52, 32 | 0.323, 0.365, 0.375 |
| Ni | 239, 183, 114 | 186, 229, 153 | 93.2, 67, 41 | 0.285, 0.365, 0.375 |
| Pb | 29.1, 31, 20 | 44.8, 36, 27 | 10.5, 11, 7 | 0.392, 0.36, 0.37 |
| Pd | 146, 146, 90 | 193, 182, 122 | 53.2, 53, 33 | 0.374, 0.365, 0.375 |
| Pt | 181, 188, 117 | 283, 235, 154 | 65.1, 69, 42 | 0.393, 0.365, 0.375 |
| StdDev | ±3%, Avg. +4% | ±3%, Avg. +4% | ±3%, Avg. +4% | ±0.005, ±0.04, ±0.04 |
| to Expt | (±14%), Avg. −35% | (±23%), Avg. −30% | (±18%), Avg. −36% | |
| | (±9%) | (±15%) | (±11%) | |

Every entry consists of the experimental value (bold), followed by the computed values using the new 12-6 and the new 9-6 LJ parameters.
^{a}Experimental results differ between independent sources up to a few percent at 298 K.

The invention shows the development of 12-6 and 9-6 Lennard-Jones parameters for the simulation of metals and hybrid interfaces with organic, inorganic, and biological compounds. Densities, surface energies, interface energies, as well as mechanical properties are computed in good agreement with experiment under ambient conditions, with average deviations of 0.1%, 3%, 10%, and 25%, respectively. The parameters are developed for room temperature and atmospheric pressure and valid in a 298±200 K range, with the possibility of adjustments for significantly different conditions. The compatibility of the LJ parameters for fcc metals with existing biomolecular and materials-oriented force fields using standard combination rules has been demonstrated through the near-quantitative computation of metal-water interface tensions using two force fields with different combination rules. The new LJ models for fcc metals can be implemented in force fields such as AMBER, CHARMM, COMPASS, CVFF, OPLS-AA, PCFF, and applied to the simulation of metals and their interfaces with water, biopolymers, organic molecules and inorganic components. The Lennard-Jones models for fcc metals are typically an order of magnitude more accurate than previous LJ parameters due to the physical interpretation of the quantities r₀ and ∈₀ in terms of the metal density and the surface tension of the {111} crystal face under standard conditions. Anticipated deviations in interfacial thermodynamic properties from experiment amount to only ˜10% in comparison to ˜100% with earlier LJ models. The model is computationally very efficient and easy to implement in Monte Carlo and molecular dynamics simulations due to its simplicity. In comparison with embedded atom and tight-binding models, the LJ potential is of comparable accuracy and computationally up to a million times faster. It is found that 12-6 LJ parameters may provide somewhat better simulation over 9-6 parameters for the metals due to better performance in the computation of mechanical properties. Moreover, the models perform well in the computation of quantities they were not originally fitted to. The surface energy anisotropy between the {100} and the {111} metal faces is computed in good agreement with experiment and appears to be related to the geometry of the crystal faces. Elastic properties are computed in good qualitative agreement with experiment which appears to be a consequence of the more exact representation of solid-vapor interface tensions under ambient conditions.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. Additional features of the invention will become apparent to those skilled in the art upon consideration of the description. Modifications may be made without departing from the spirit and scope of the invention.

1.-21. (canceled)

22. A computer-implemented system for developing molecular mechanics force field parameters for computer simulations of molecular systems, comprising:
a) means for creating or importing molecular models to a processor based platform, the molecular models representing said molecular systems having at least one metal to be parameterized;
b) means for retrieving stored Lennard-Jones parameters relating to at least one metal, wherein said Lennard-Jones parameters relate to surface and interface properties, and wherein the Lennard-Jones parameters deviate less than between 1% and 20%;
c) means for preparing input data for said molecular models;
d) means for importing said prepared data for said molecular models;
e) means for selecting force field type and functional forms, and assigning atom types to said molecular models;
f) means for providing force field parameters for said molecular models based on said molecular models; and
g) means for exporting said force field parameters in predetermined formats to at least one external molecular mechanics simulation package and saving the molecular models, input data and force field parameters to a database.

23. The system of claim 22, wherein the Lennard-Jones parameters relate to at least one fcc metal, said parameters relating to adjustment of two parameters r₀ and ∈₀ to densities and surface tensions of the at least one fcc metal at a given temperature.

24. The system of claim 23, wherein the parameters provide in conjunction with the simulation techniques a prediction of at least one characteristic selected from the group consisting of surface energies, surface energy anisotropies, mechanical properties, adsorption energies, self-assembly processes as relevant for the synthesis, growth and characterization of metal nanostructures in precursor solutions, specific adsorption of surfactants, organic molecules, and biological molecules on regular and irregular metal, bimetal, and alloy surfaces, diffusion processes at metal surfaces, binding constants, and combinations thereof.

25. The system of claim 23, wherein the at least two parameters r₀ and ∈₀ for a 12-6 Lennard-Jones potential are approximately 2.995 Å and approximately 4.56 kcal/mol respectively, and for a 9-6 Lennard-Jones potential are approximately 3.005 Å and approximately 3.73 kcal/mol respectively, for Ag.

26. The system of claim 23, wherein the at least two parameters r₀ and ∈₀ for a 12-6 Lennard-Jones potential are approximately 2.925 Å and approximately 4.02 kcal/mol respectively, and for a 9-6 Lennard-Jones potential are approximately 2.976 Å and approximately 3.26 kcal/mol respectively, for Al.

27. The system of claim 23, wherein the at least two parameters r₀ and ∈₀ for a 12-6 Lennard-Jones potential are approximately 2.951 Å and approximately 5.29 kcal/mol respectively, and for a 9-6 Lennard-Jones potential are approximately 3.003 Å and approximately 4.32 kcal/mol respectively, for Au.

28. The system of claim 23, wherein the at least two parameters r₀ and ∈₀ for a 12-6 Lennard-Jones potential are approximately 2.616 Å and approximately 4.72 kcal/mol respectively, and for a 9-6 Lennard-Jones potential are approximately 2.661 Å and approximately 3.84 kcal/mol respectively, for Cu.

29. The system of claim 23, wherein the at least two parameters r₀ and ∈₀ for a 12-6 Lennard-Jones potential are approximately 2.552 Å and approximately 5.65 kcal/mol respectively, and for a 9-6 Lennard-Jones potential are approximately 2.598 Å and approximately 4.59 kcal/mol respectively, for Ni.

30. The system of claim 23, wherein the at least two parameters r₀ and ∈₀ for a 12-6 Lennard-Jones potential are approximately 3.565 Å and approximately 2.93 kcal/mol respectively, and for a 9-6 Lennard-Jones potential are approximately 3.662 Åand approximately 2.47 kcal/mol respectively, for Pb.

31. The system of claim 23, wherein the at least two parameters r₀ and ∈₀ for a 12-6 Lennard-Jones potential are approximately 2.819 Å and approximately 6.15 kcal/mol respectively, and for a 9-6 Lennard-Jones potential are approximately 2.868 Å and approximately 5.03 kcal/mol respectively, for Pd.

32. The system of claim 23, wherein the at least two parameters r₀ and ∈₀ for a 12-6 Lennard-Jones potential are approximately 2.845 Å and approximately 7.80 kcal/mol respectively, and for a 9-6 Lennard-Jones potential are approximately 2.896 Å and approximately 6.38 kcal/mol respectively, for Pt.

33. A method for developing molecular mechanics force field parameters for computer simulations of molecular systems including at least one metal, comprising:
a) creating or importing molecular models to a processor based platform, the molecular models representing said molecular systems having at least one metal to be parameterized;
b) retrieving stored Lennard-Jones parameters relating to the at least one metal, wherein said Lennard-Jones parameters relate to surface and interface properties, and wherein the Lennard-Jones parameters deviate less than between 1% and 20%;
c) preparing input data for said molecular models based on at least values of density and surface tension associated for the at least one metal;
d) selecting force field type and functional forms, and assigning atom types to said molecular models;
e) providing force field parameters for said molecular models based on said molecular models; and
f) exporting said force field parameters in predetermined formats to at least one external molecular mechanics simulation package on a processor based platform and saving the molecular models, input data and force field parameters to a database.

34. The method of claim 33, wherein the at least one external molecular mechanics simulation package is selected from the group consisting of AMBER, CHARMM, COMPASS, CVFF, OPLS-AA, and PCFF and Monte Carlo methods.

35. The method of claim 33, wherein the Lennard-Jones parameters provide in conjunction with the simulation techniques a prediction of at least one characteristic of the at least one metal selected from the group consisting of surface energies, surface energy anisotropies, mechanical properties, adsorption energies, self-assembly processes as relevant for the synthesis, growth and characterization of metal nanostructures in precursor solutions, specific adsorption of surfactants, organic molecules, and biological molecules on regular and irregular metal, bimetal, and alloy surfaces, diffusion processes at metal surfaces, binding constants, and combinations thereof.

36. The method of claim 33, wherein the Lennard-Jones parameters provide in conjunction with the simulation techniques, simulation of the at least one metal and a variety of interfaces with biopolymers, surfactants, and nano structured materials.

37. The method of claim 33, wherein the at least one metal is a fcc metal.

38. The method of claim 33, wherein the Lennard-Jones parameters are provided at a predetermined temperature, and wherein the predetermined temperature is substantially ambient temperature.

39. The method of claim 33, wherein the Lennard-Jones parameters are provided at a predetermined pressure, and wherein the predetermined pressure is substantially ambient pressure.

40. The method of claim 33, further comprising providing Lennard-Jones parameters using combination rules to derive the parameters ∈_{0,ij} and r_{0,ij} for non-bond interactions between different atom types i and j.

41. A method of deriving Lennard-Jones potentials for metal materials, comprising:
a) determining the values of at least density and surface tension at a predetermined temperature for a predetermined metal:
b) transforming data representative of the predetermined metal relating said values of at least density and surface tension into first estimates of at least the two parameters r₀ and ∈₀ of a Lennard-Jones model using a processor based platform;
c) computing the density and surface tension using said first estimates in a NPT and/or NVT molecular dynamics simulation on a processor based platform,
d) using the computed density and surface tension to derive at least second estimates of said at least two parameters r₀ and ∈₀ to adjust the values of said at least two parameters r₀ and ∈₀;
e) computing the density and surface tension using said second estimates in a NPT and/or NVT molecular dynamics simulation,
f) determining if the second estimates provide predetermined results from the computation in step e), and if said predetermined results are not provided;
g) repeating steps c)-f) to derive third or more estimates of said at least two parameters r₀ and ∈₀ until predetermined results from the computation in a NPT and/or NVT molecular dynamics simulation are provided to yield Lennard-Jones potentials for use in simulations in association with said predetermined metal.

42. The method of claim 41, wherein the step of using the computed density and surface tension to derive at least second estimates of said at least two parameters r₀ and ∈₀ uses linear interpolation to adjust the values of said at least two parameters r₀ and ∈₀.
